(19) United States
(12) Patent Application Publication
(10) Pub. No.: US 2019/0366945 A1
(43) Pub. Date: Dec. 5, 2019

(54) Cargo Guard Kit for Protecting the Bed and the Cargo on a Pickup Truck

(71) Applicant: Michael Campbell, Camano Island, WA (US)

(72) Inventor: Michael Campbell, Camano Island, WA (US)

(21) Appl. No.: 16/031,785

(22) Filed: Jul. 10, 2018

Related U.S. Application Data
(63) Continuation-in-part of application No. 29/649,753, filed on Jun. 1, 2018.

(51) Int. Cl. B60R 13/04

(52) U.S. Cl. CPC B60R 13/04

(57) ABSTRACT

A cargo guard kit for protecting the cargo and the bed of a pickup truck includes protective pads. Each protective pad includes a flexible friction pad and at least one shielding strip. The flexible friction pad attaches the shielding strip to the contact point on the pickup truck. Similarly, the shielding strip protects the surface of the contact point. The flexible friction pad has a contact face and a fastening face. The at least one shielding strip is mounted onto the contact face. The fastening face is positioned facing opposite to the contact face and is designed to connect to the exterior surface of the pickup truck. The at least one shielding strip is mounted into the middle of the flexible friction pad. As such, the width of the flexible friction pad is greater than the width of the at least one shielding strip. In contrast, the length of the flexible friction pad is equal to the length of the shielding strip.

### FIELD OF THE INVENTION

The present invention generally relates to cargo guard kit for pickup trucks. More specifically, the cargo guard kit utilizes protective pads designed to shield specific parts on the pickup truck.

### BACKGROUND OF THE INVENTION

Usually, the cargo bed of the pickup truck is treated with a protective coating to shield the underlying surface from scratches, nicks, and marks made when loading and unloading cargo. Generally, the coating is also applied to the side panels facing the cargo bed and the interior surface of the tailgate. Although an expensive process, the protective coating protects the bed from cosmetic damage that can often lead to more serious damage to the internals of the truck. However, in many cases, loading and unloading cargo often ends up damaging untreated parts of the truck such as the cabin. In some cases, the cabin may also be used to support the cargo. For example, a ladder may be laid on top of the cabin in order to fit it into the bed. This can easily lead to scratches or dents that may cost hundreds of dollars to repair.

The present invention provides a versatile and cost-efficient way of providing whole-body protection for the truck. The present invention is a cargo guard kit designed to protect specific parts of a pickup truck. More specifically, the cargo guard kit utilizes protective pads that can be mounted onto contact points between the cargo and the pickup truck. As in the case of the ladder, the contact points may not always be located on the bed. Thus, the protective pads are designed to mount anywhere on the exterior surface of the truck. All the protective pads use a flexible friction pad and at least one shielding strip. Depending on where the protective pad is intended to be mounted, there may be more than one shielding strips. Further, the shape of the shielding strip may also change to conform to different areas on the truck. Finally, the protective pads may also be mounted directly to the cargo, at locations corresponding to contact points. As such, this removes the need for an expensive protective coating to be applied permanently to large portions of the truck.

### BRIEF DESCRIPTION OF THE DRAWINGS

FIG. 1 is a perspective view illustrating the cargo guard kit being mounted onto a plurality of contact points on the SUV.

FIG. 2 is a top perspective view of an exemplary embodiment of the protective pad.

FIG. 3 is a side view of the protective pad showing the contact face and the fastening face.

FIG. 4 is a top view of the protective pad with a pair of shielding strips separated by the hinging gap.

FIG. 5 is a top perspective view of the protective pad with the L-shaped panel.

FIG. 6 is an exploded view illustrating the interior surface of the L-shaped panel.

FIG. 7 is a perspective view of the protective pad designed to mount onto the cargo.

FIG. 8 is an exploded view of the cargo-mounted protective pad illustrating the interior surface of the L-shaped panel.

FIG. 9 is a top perspective view of the protective pad utilizing the U-shaped panel.

FIG. 10 is an exploded view of the protective pad illustrating the concave face of the U-shaped panel.

FIG. 11 is a bottom perspective view of the protective pad with a flexible magnetic sheet as the magnetic backing.

FIG. 12 is a bottom perspective view of the protective pad utilizing the plurality of gripping protrusions.

### DETAILED DESCRIPTION OF THE INVENTION

All illustrations of the drawings are for the purpose of describing selected versions of the present invention and are not intended to limit the scope of the present invention.

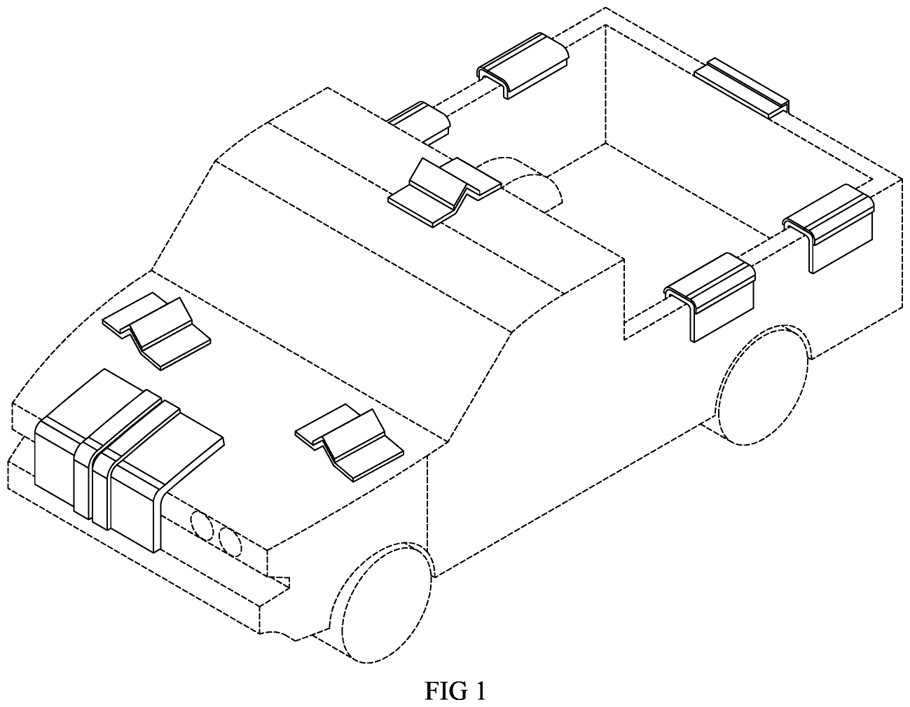

Referring to FIG. 1, a cargo guard kit shields and protects the cargo bed of a pickup truck and the cargo being loaded thereon. The cargo guard kit comprises different types of protective pads designed to attach to different portions of the pickup truck. The protective pads can also be attached to portions of the cargo that contact the cargo bed. The cargo kit also comes with a nylon bag for carrying the cargo kit and a flag for marking the position of the cargo. The flag is particularly useful when the cargo occupies the driver's blind spot. For example, if the cargo extends past the tailgate, the flag can help the driver judge the position of the cargo when making wide turns.

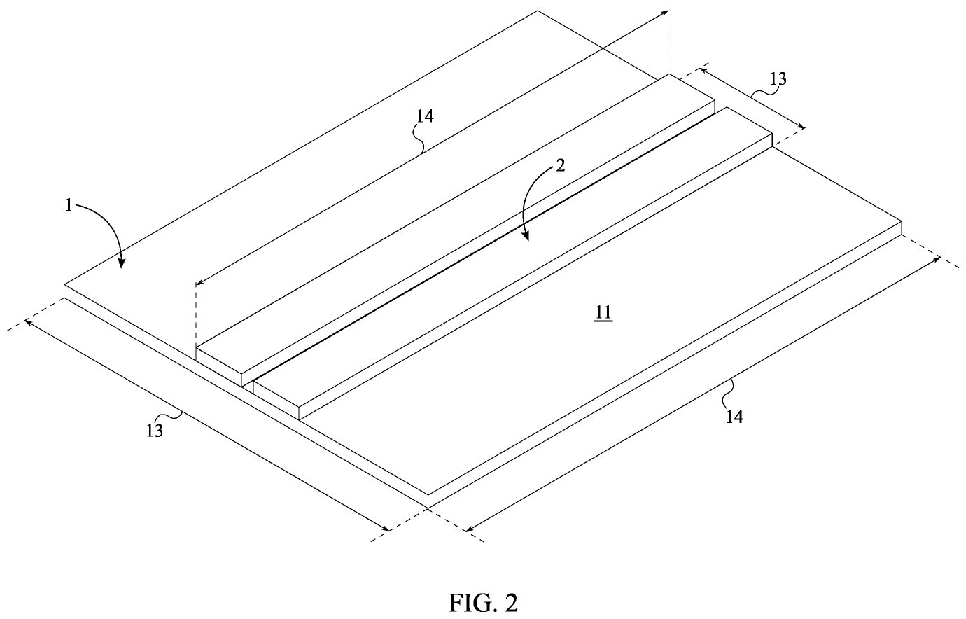

Referring to FIG. 2, in the preferred embodiment of the present invention, each protective pad comprises a flexible friction pad 1 and at least one shielding strip 2. The flexible friction pad 1 comprises a contact face 11 and a fastening face 12. Accordingly, the contact face 11 and the fastening face 12 is positioned opposite to each other through the flexible friction pad 1. More specifically, the contact face 11 is oriented towards the cargo whereas the fastening face 12 is oriented towards the exterior surface of the pickup truck. As a result, the fastening face 12 secures the flexible friction pad 1 to the exterior surface of the truck.

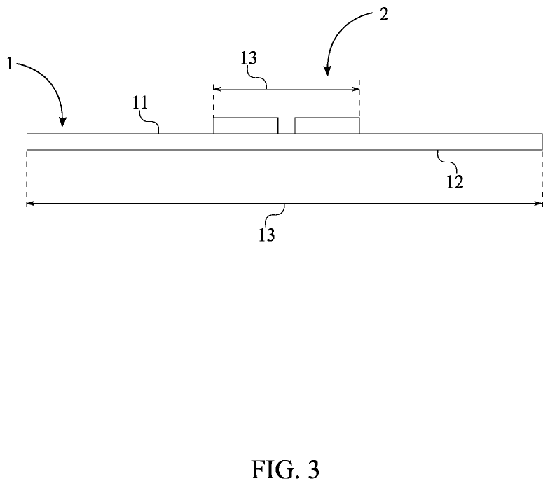

Referring to FIG. 3, the shielding strip 2 is connected across the contact face 11 of the flexible friction pad 1. The preferred shielding strip 2 is a thick plastic strip that protects both the cargo bed and the flexible friction pad 1 from the scratches and dents caused by the relative motion of the cargo and truck. As such, the flexible friction pad 1 is positioned between the contact point of the cargo and the contact point of the truck. A width 13 of the flexible friction pad 1 is greater than a width 13 of the shielding strip 2. Further, a length 14 of the flexible friction pad 1 is equal to a length 14 of the shielding strip 2. This increases the grip between the flexible friction pad 1 and the contact point of the truck, thereby making the flexible friction pad 1 more resilient to the movement of the cargo.

The flexible friction pad 1 is made of a soft plastic that bends and flexes to conform to the exterior surfaces of the truck. In the preferred embodiment of the present invention, the flexible friction pad 1 is made of neoprene. Neoprene is selected for its flexible qualities as well as its high friction coefficient which prevents the flexible friction pad 1 from sliding around easily. Alternately, the flexible friction pad 1 may be made of any other suitable flexible or fabric material having a high friction coefficient.

In contrast, the shielding strip 2 is made of a hard plastic that prevents the cargo from damaging the exterior surface of the pickup truck. In the preferred embodiment, the shielding strip 2 is made of a thick layer of densely packed plastic, resistant against repeated nicks, tears, and scratches made by the cargo. Alternately, the shielding strip 2 may be made of densely-packed metallic or organic materials.

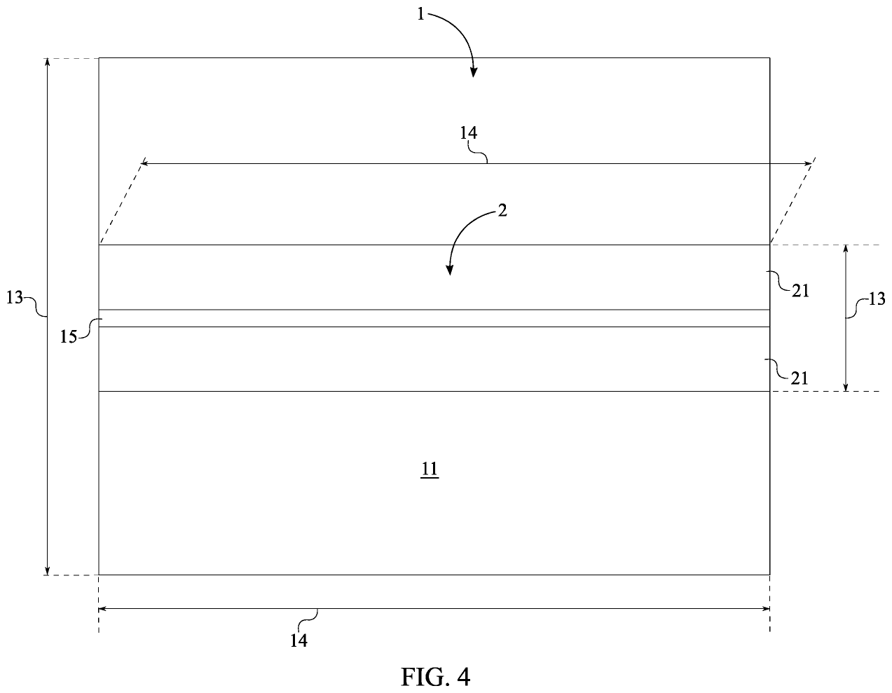

Referring to FIG. 4, in the preferred implementation, the at least one shielding strip 2 is configured to attach to different areas on the pickup truck. In one possible embodiment, the at least one shielding strip 2 may be configured to attach across the cabin of the pickup truck. Accordingly, the at least one shielding strip 2 comprises a pair of shielding strips 21. Preferably, the pair of shielding strips 21 is positioned parallel to each other. Further, the pair of shielding strips 21 is positioned offset from each other by a hinging gap 15. This allows the pair of shielding strips 21 to conform to angled surfaces such as the corners of the cabin. In particular, the hinging gap 15 allows the pair of shielding strips 21 to be mounted between the rear window and the roof of the cabin. For example, the corner edge of the cabin may be used to support a ladder on the cabin bed. In this case, the pair of shielding strips 21 extends across the cabin thereby preventing the ladder from sliding sideways as the truck takes a corner. The pair of shielding strips 21 is also centrally positioned along the width 13 of the flexible friction pad 1. A user can thus fold the flexible friction pad 1 along the hinging gap 15 for ease of storage. This also increases the permissible size of the flexible friction pad 1 in the unfurled configuration.

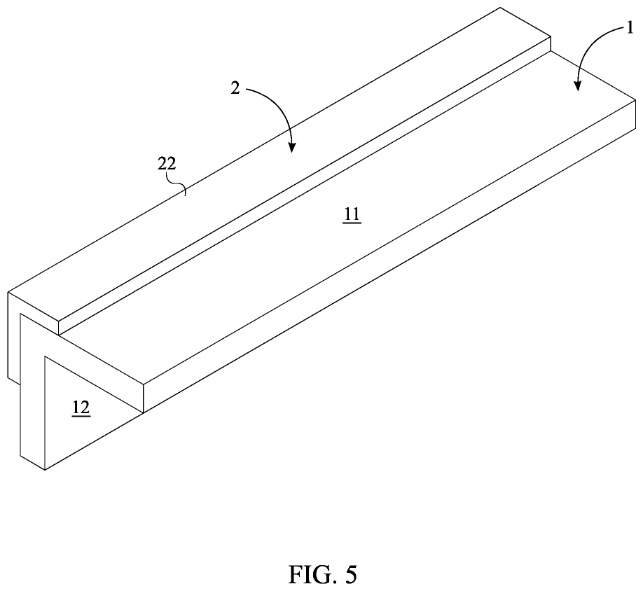

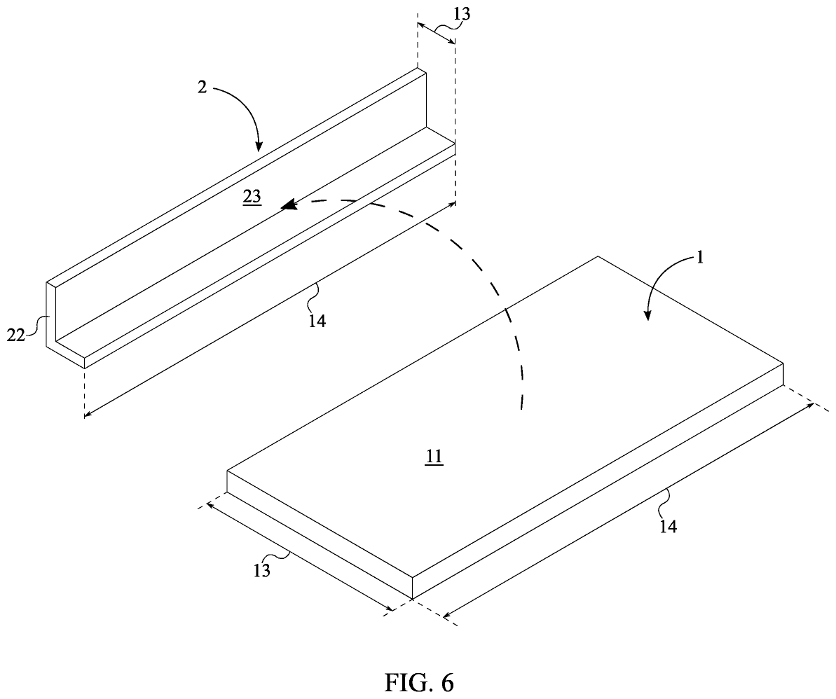

Referring to FIG. 5 and FIG. 6, in another possible embodiment of the present invention, the protective pad is designed to mount onto the side panel or the tailgate of the cargo bed. Accordingly, the at least one shielding strip 2 is a L-shaped panel 22. Preferably, the L-shaped attaches at a right angle to the corner edge of the side panel or the tailgate. As such, the L-shaped panel 22 is constructed out of two flat pieces arranged in a 90-degree angle. Alternately, the L-shaped panel 22 may have an oblique or acute angle depending on the angle of the corner edge. The interior face of the L-shaped panel 22 is lined with the flexible friction pad 1. More specifically, the contact face 11 of the flexible friction pad 1 is connected onto the interior surface 23 of the L-shaped panel 22. Accordingly, the fastening face 12 of the flexible friction pad 1 faces outwards towards the corner edge. Once the L-shaped panel 22 is fitted over the corner edge of the side panel, the flexible friction pad 1 fastens the L-shaped panel 22 to the side panel. In addition, the flexible friction pad 1 also provides cushioning between the side panel and the L-shaped panel 22. The L-shaped panel 22 is centrally attached to the flexible friction pad 1. The flexible friction pad 1 extending from the sides of the L-shaped panel 22 act as flaps that attach to the side and the top of the side panel. The flaps can also be used to easily detach the flexible friction pad 1 from the side panel. To maximize the gripping force generated by the flexible friction pad 1, the L-shaped panel 22 extends across the length 14 of the flexible friction pad 1. In the preferred embodiment, the flexible friction pad 1 has a length 14 of 16 inches and a width 13 of 8 inches. As such, a ratio between the length 14 of the flexible friction pad 1 and the width 13 of the flexible friction pad 1 is 2:1. Generally, it is desirable to increase the surface area of the flexible friction pad 1 to generate a high gripping force which can resist vibrations.

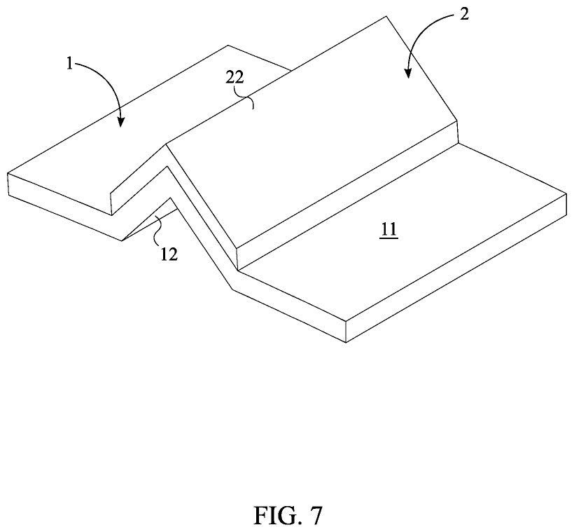

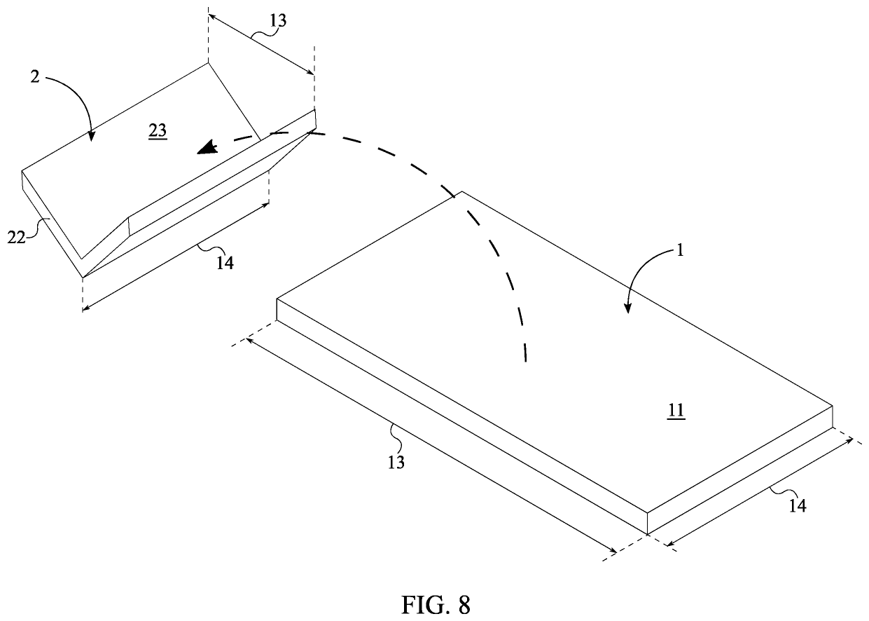

Referring to FIG. 7 and FIG. 8, in another embodiment of the present invention, the protective pads may be attached to the cargo. In the preferred implementation, a plurality of protective pads is employed to protect the cargo. More specifically, a protective pad is positioned between each contact point between the cargo and the rope. In this embodiment, a ratio between the length 14 of the flexible friction pad 1 and the width 13 of the flexible friction pad 1 is 1:2. This increases the area of the flexible friction pad 1 that is employed to attach the shielding strip 2. As such, the shielding strip 2 protects the cargo from scratches, nicks, and rub marks made by straps or ropes used to secure the cargo. Preferably, for cargos with straight edges, the L-shaped panel 22 is attached to each corner edge of the cargo. For example, if the cargo is a box, a protective pad may be positioned at each corner edge of the box. In this case, the corner edge may fit into the L-shaped panel 22. Alternately, the protective pad may also be used on cargo with curved exterior surfaces. In this case, the L-shaped panel 22 protrudes above the exterior surface of the cargo and deflects the rope or strap away from the cargo.

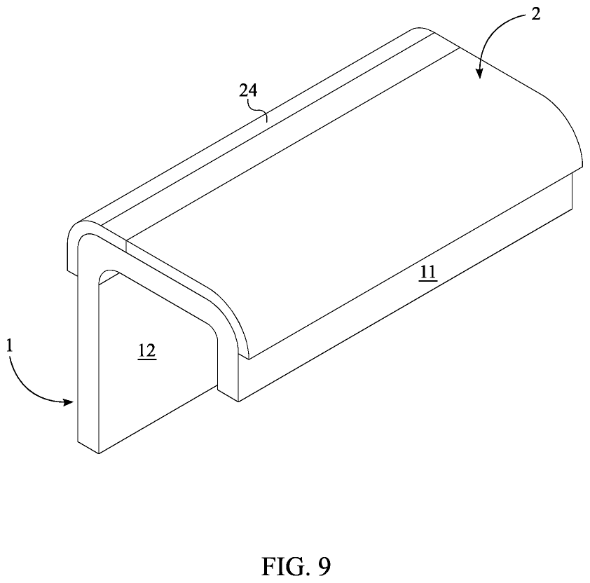

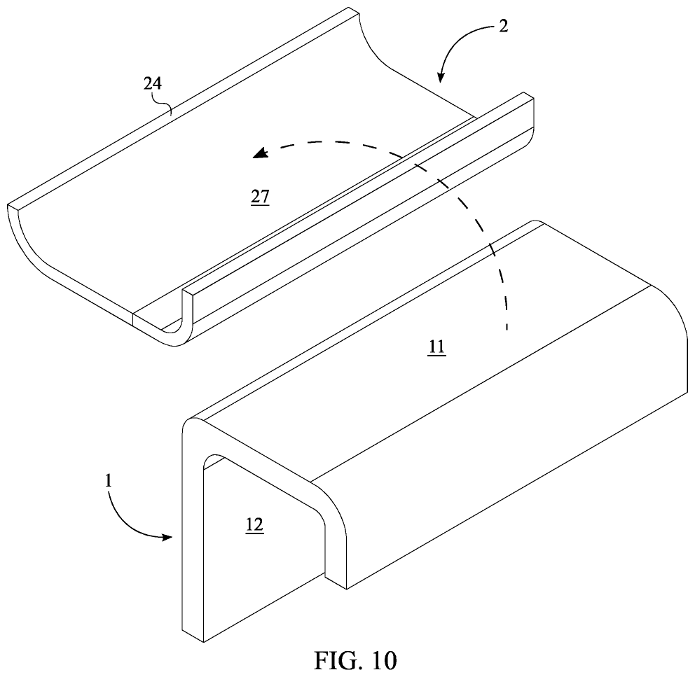

Referring to FIG. 9 and FIG. 10, in yet another embodiment of the present invention, the protective pad is configured to attach to the top of the side panels. As such, the at least one shielding strip 2 is a U-shaped panel 24. As with the L-shaped panel 22, the interior surface 23 of the U-shaped panel 24 is lined with the flexible friction pad 1. As such, the contact face 11 is connected onto a concave surface 27 of the U-shaped panel 24. In the preferred implementation, the concave face 27 of the U-shaped panel 24 fits over the top of the side panel and a convex face that contacts the cargo. While the parallel legs that point downwards secure the convex face against side force, flexible friction pad 1 prevents the U-shaped panel 24 from sliding along the length of the side panel.

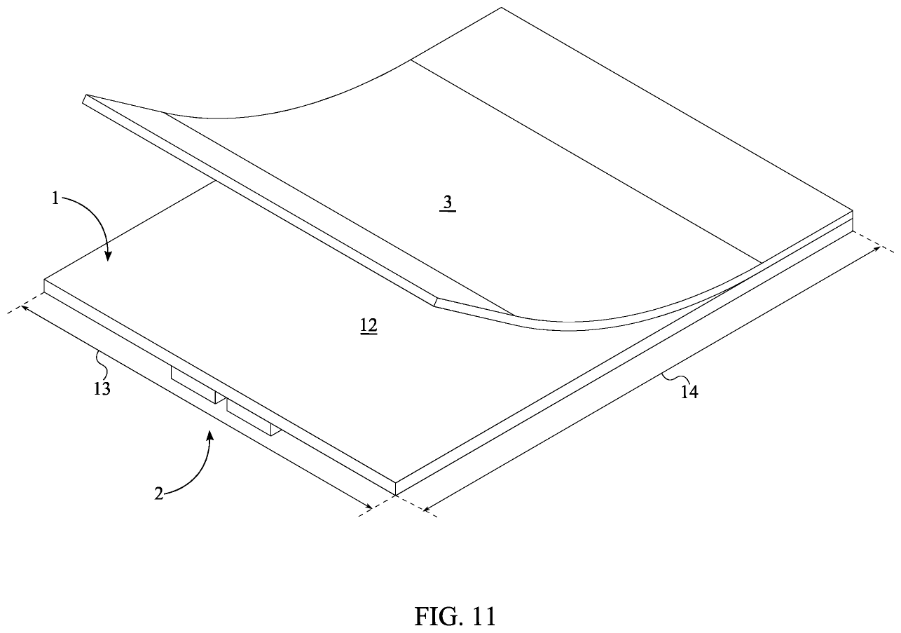

Referring to FIG. 11, the preferred embodiment of the flexible friction pad 1 utilizes at least one magnetic backing 3 to securely fasten onto the pickup truck. The magnetic backing 3 may be a thin flexible magnetic sheet glued, connected, or fastened onto the fastening face 12. Alternately, the magnetic backing 3 may comprise a plurality of magnets placed into slots that are integrated into the flexible friction pad 1. In all cases, the magnetic backing 3 is connected across the fastening face 12. The magnetic backing 3 forms a magnetic bond with the metallic exterior surface of the pickup truck. Further, the magnetic backing 3 may be strong enough to magnetically bond with metallic surfaces hidden behind non-magnetic materials. For example, the magnetic backing 3 may magnetic bond with the metallic frame of the side panel that is hidden behind plastic trim pieces.

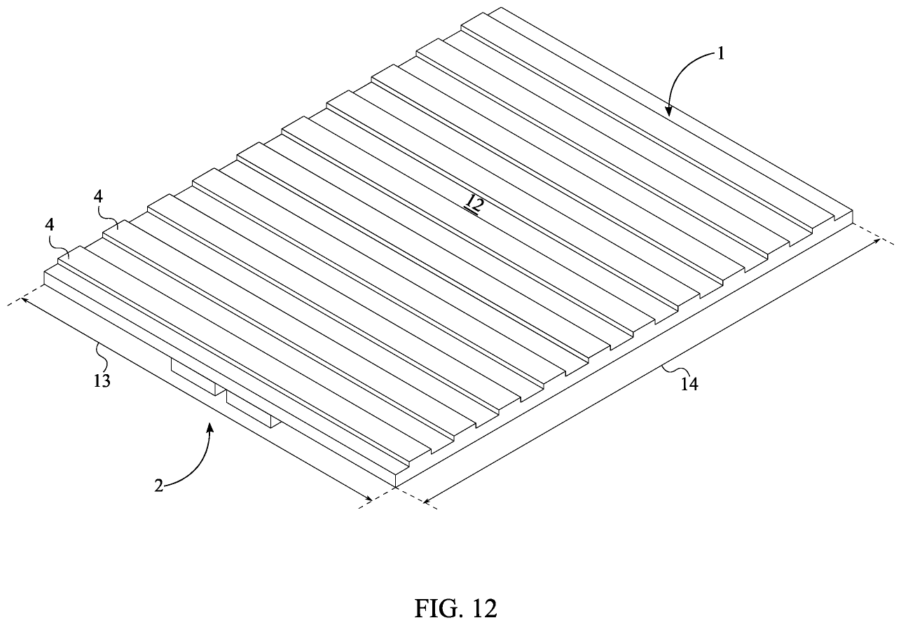

Referring to FIG. 12, a plurality of gripping protrusions 4 may be used instead or in addition to the magnetic backing 3. The plurality of gripping protrusions 4 is preferably connected across the fastening face 12. The plurality of gripping protrusions 4 may be distributed evenly on the fastening face 12 or may be concentrated on the center or the periphery of the fastening face 12. Each of the gripping protrusion 4 may be made of a rigid rubber or plastic material.

Although the invention has been explained in relation to its preferred embodiment, it is to be understood that many other possible modifications and variations can be made without departing from the spirit and scope of the invention as hereinafter claimed.

What is claimed is:

1. A cargo guard kit for protecting the bed and the cargo on a pickup truck comprises:
a flexible friction pad;
at least one shielding strip;
the flexible friction pad comprises a contact face and a fastening face;
the contact face and the fastening face being positioned opposite to each other through the flexible friction pad;
the shielding strip being connected across the contact face;
a width of the flexible friction pad being greater than a width of the shielding strip; and
a length of the flexible friction pad being equal to a length of the shielding strip.

2. The cargo guard kit for protecting the bed and the cargo on a pickup truck as claimed in claim 1, wherein the flexible friction pad is made of soft plastic.

3. The cargo guard kit for protecting the bed and the cargo on a pickup truck as claimed in claim 1, wherein the shielding strip is made of hard plastic.

4. The cargo guard kit for protecting the bed and the cargo on a pickup truck as claimed in claim 1 comprises:
the at least one shielding strip comprises a pair of shielding strips;
the pair of shielding strips being positioned parallel to each other;
the pair of shielding strips being positioned offset from each other by a hinging gap; and
the pair of shielding strips being centrally positioned along the width of the flexible friction pad.

5. The cargo guard kit for protecting the bed and the cargo on a pickup truck as claimed in claim 1 comprises:
the at least one shielding strip being a L-shaped panel; and
the contact face being connected onto an interior surface of the L-shaped panel.

6. The cargo guard kit for protecting the bed and the cargo on a pickup truck as claimed in claim 6 comprises:
a ratio between the length of the flexible friction pad and the width of the flexible friction pad is 2:1.

7. The cargo guard kit for protecting the bed and the cargo on a pickup truck as claimed in claim 6 comprises:
a ratio between the length of the flexible friction pad and the width 13 of the flexible friction pad is 1:2.

8. The cargo guard kit for protecting the bed and the cargo on a pickup truck as claimed in claim 1 comprises:
the at least one shielding strip being a U-shaped panel; and
the contact face being connected onto a concave surface of the U-shaped panel.

9. The cargo guard kit for protecting the bed and the cargo on a pickup truck as claimed in claim 1 comprises:
at least one magnetic backing; and
the magnetic backing being connected across the fastening face.

10. The cargo guard kit for protecting the bed and the cargo on a pickup truck as claimed in claim 1 comprises:
a plurality of gripping protrusions; and
the plurality of gripping protrusions being connected across the fastening face.

11. A cargo guard kit for protecting the bed and the cargo on a pickup truck comprises:
a flexible friction pad;
at least one shielding strip;
at least one magnetic backing;
the flexible friction pad comprises a contact face and a fastening face;
the contact face and the fastening face being positioned opposite to each other through the flexible friction pad;
the shielding strip being connected across the contact face;
a width of the flexible friction pad being greater than a width of the shielding strip;
a length of the flexible friction pad being equal to a length of the shielding strip; and
the magnetic backing being connected across the fastening face.

12. The cargo guard kit for protecting the bed and the cargo on a pickup truck as claimed in claim 11, wherein the flexible friction pad is made of soft plastic.

13. The cargo guard kit for protecting the bed and the cargo on a pickup truck as claimed in claim 11, wherein the shielding strip is made of hard plastic.

14. The cargo guard kit for protecting the bed and the cargo on a pickup truck as claimed in claim 11 comprises:
the at least one shielding strip comprises a pair of shielding strips;
the pair of shielding strips being positioned parallel to each other;
the pair of shielding strips being positioned offset from each other by a hinging gap; and
the pair of shielding strips being centrally positioned along the width of the flexible friction pad.

15. The cargo guard kit for protecting the bed and the cargo on a pickup truck as claimed in claim 11 comprises:
the at least one shielding strip being a L-shaped panel; and
the contact face being connected onto an interior surface of the L-shaped panel.

16. The cargo guard kit for protecting the bed and the cargo on a pickup truck as claimed in claim 15 comprises:
a ratio between the length of the flexible friction pad and the width of the flexible friction pad is 2:1.

17. The cargo guard kit for protecting the bed and the cargo on a pickup truck as claimed in claim 15 comprises:
a ratio between the length of the flexible friction pad and the width of the flexible friction pad is 1:2.

18. The cargo guard kit for protecting the bed and the cargo on a pickup truck as claimed in claim 11 comprises:
the at least one shielding strip being a U-shaped panel; and
the contact face being connected onto a concave surface of the U-shaped panel.
